(19) United States
(12) Patent Application Publication
(10) Pub. No.: US 2004/0218238 A1
(43) Pub. Date: Nov. 4, 2004

(54) Method of creating hoolgraphic image on printing surface

(76) Inventors: Yong Xie, Zhuzhou City (CN); Weigang Yang, Zhuzhou City (CN); Jianxin Tang, Zhuzhou City (CN); Hongxun Chi, Zhuzhou City (CN); Tao Peng, Zhuzhou City (CN)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/478,654

(22) PCT Filed: Dec. 7, 2001
(86) PCT No.: PCT/CN01/01609

(30) Foreign Application Priority Data
May 28, 2001 (CN) 01114494.7

(51) Int. Cl. G03H 1/02

(52) U.S. Cl. 359/3

(57) ABSTRACT

A method of creating holographic image on printed surface including the following steps: A. selecting a basis material; B. printing conventional printing pattern layer upon thed basis material layer; C. coating a transparent medium of holographic coating layer used to create holographic pattern upon the surface of printed pattern layer, wherein the medium is transparent thermoplastic material containing solvent type copolymerised resin; the holographic coating layer is produced by the holographic coated medium heated and dried by the infrared; and D. embossing the material with holographic coating layer by heating installing dolographic form on the outer surface of the form roller of the embossing machine; when the material with holographic coating layer is conveyed to the embossing machine, the holographic coating layer is embossed and the holographic image is produced under the pressure of the holographic form while the holographic coating layer is softened by heat.

### FIELD OF THE INVENTION

The invention is involved in a laser holographic image forming technique, especially in creating holographic image directly on printed surface.

### BACKGROUND OF THE INVENTION

As a practical means of anti-counterfeiting, holographic image receives favor from customers and has an unprecedented development. Till now laser hologram acts as a mainstream technique in the field of public anti-counterfeiting worldwide. Easy to identify, hard to copy and suit to mass produce, this technique can hardly be substituted in a short time. Hologram is almost regarded as identical to anti-counterfeiting nowadays.

The emerging of computerized dot-matrix holographic mastering system, which marked the holographic plate-making from a analog age to a digital age, shortened the holographic plate-making period from more than ten days to one or two days, and lowered the production cost greatly. And it also paved the way for realization of the 3-D real-colored holographic image.

At present, embossing technique (hard-emboss/soft-emboss) still prevails in holographic reproduction, the types of using holographic image on products are mainly as follows:

A. Pasting holographic label. Initially people pasted the label on package by hand, which was time-consuming, inefficient and ranked as outdated practice. Later an automatic pasting label technique of higher efficiency came into being, but special equipments were required and higher quality on the joints of embossing plate was needed. This way is utilized in a part of enterprises now and it suits general trademarks.

B. Laminating (e.g. P.R.China patent No.ZL99109562). This method needed many working procedures, special equipments and materials n and higher cost, so it suits limited fields.

C. Hot-stamping (e.g. P.R.China patent No.ZL001 15394). It is a successful application of the technique. Its high yield, eg.10,000 pieces per hour, and accurate location ensure high profits of the enterprises using it. But it restrains itself from a further development due to the expensive equipments and materials.

In a word, all kinds of holographic techniques used today have common features as follows:

A. Usually use plastic film as the holographic basis material

B. Must be metallized

C. Holographic imaging and production (printing and shaping) are two independent procedures. Holographic image is commonly produced before it is printed upon, except for hot stamping.

D. As for some paper-plastic-aluminum laminated products with hologram, to observe the hologram a transparent ink has to be used to print text and pattern (means to printing on metal substrate), which changes the original printing technique and costs more as well.

Though the American patent (U.S. Pat. No. 5,155,604) has made public a way that a layer of heat-sensitive material coated on paper or plastic basis material as holographic image produce layer is heated and embossed to create holographic image, we find it different from so-called holographic anti-counterfeiting processing on printed surface, for the former is aimed at creating holographic decorative patterns in forms of holographic photo papers and films and is done on the non-printing surface.

To create laser holographic image directly on the printed basis material proves no easy job, for it may be at the expense of the intactness of the print or an adequate adhesion of the holographic image to the printing layer. There is room for the traditional holographic technique to improve, regarding the laser holographic image as non-ink-printing patterns and rendering the pattern and color of the design by optical diffraction efficiency.

### SUMMARY OF THE INVENTION

Aiming at solving the problem of prevalent holographic technique for anti-counterfeiting, the present invention provides a method of creating laser holographic image on the ink printed surface by special process.

Another purpose of the invention is to offer a definite method of creating the laser holographic image.

The aims of the invention can be achieved by the steps as follows: Such material as paper, plastic, metal or leather is chosen as the basis material in forms of sheet material or roll material. It is firstly ink printed in conventional printing process to create a printing pattern layer, and then coated a layer of transparent holographic coating which has the laser holographic image printing function. The layer can be coated by means of rolling, or spraying, or brushing, or sprinkling with a sheer coating, a thermoplastic layer of dope, which forms a laser holographic carrier as a medium after being heated by infrared. For the rougher basis material (e.g. general paper board), the coating layer can be calendered to improve the brightness and smoothness as the memorial layer of holographic image, and then be produced on the embossing machine (general-purpose embossing machines are used for roll material, but special embossing machines must be applied for sheet material). After the basis material with holographic coating carrier is entered into the embossing machine, the holographic image on the transparent holographic coating carrier, which renders the pattern and color of the design by the optical diffraction effect, is duplicated from the holographic form on the embossing roller whose hollow house is filled with hot oil to heat and soften the holographic coating.

The principle of creating holographic image on the layer of printed pattern of the basis material is almost similar to that of other traditional basis material (plastic film, aluminum-plating film), the process of which is to acquire holographic picture by means of holographic photography, then reproduce the holographic picture to holographic metal plate, and then reproduce the holographic image to the printed matters by means of thermal embossing. But the surface feature of printing layer with printing ink is obviously different from that of plastic film and aluminum-plating film, and the film itself, which can be used to produce holographic products, possesses the feature of thermoplastic transformation, and has smooth surface which makes it possible to directly press and print holographic image on it. Especially after the film is plated with aluminum, its visual effect of holographic image is greatly improved due to the deflection effect of aluminum layer. However, the condition is different for printed products, not only is it impossible to directly press and print holographic image on printing ink, but also to plate aluminum on printed matters (to cover aluminum layer with printing ink will lose the former printing effect). So, to produce patterns with holographic effect on the printing layer, a special printing medium is required for assistance, such medium should carry significant thermoplastic transformation feature, and fine stable holographic optical line is to be acquired after the transformation, meanwhile such medium must be transparent enough to guarantee the visibility of the former printing image and color, thus such special printing media of holographic image is called holographic coating.

Based on some characteristics of basis material and laser holographic image, the holographic coating adopted in this invention is transparent thermoplastic material, which is solvent type copolymerized monomer, including solvent type copolymerised resin. The solvent type copolymerized monomers synthesized a kind of copolymer resin which serves as reproducing coating for laser holographic image. Such solvent type coating is also divided into two type synthesized copolymer, alcohol resin coating or water soluble resin emulsion coating. The component of coating consists of three parts, i.e., host agent, additives and solvent. Host agent, which concerns about the quality, physical and chemical performance of film layer (such as brightness, folding strength, post processing adaptability etc.), is the substance for the coating to form film. Among different kinds of host agents, the host agent of water borne coating is the copolymerised resin produced by water borne resin and polyvinyl alcohol (PVA), and the solvent of this host agent can be liquid such as water, ether glycol, butyl alcohol etc. So a kind coating to the benefit of environment is obtained, of which excellent comprehensive performance comes into being, such as high refraction, high brightness, antifriction, pliability, water proof etc. The host agent of alcohol borne coating can be monomer copolymerised resin and polyurethane resin, and the solvent of this host agent can be the liquid also such as ether glycol and butyl alcohol. This coating carries such excellent performance as good film formation, high brightness, high transparency, antifriction, water proof, aging-resistance etc, in addition to high adaptability.

In order to obtain perfect visual effect of holographic image on the coating, the quality of the smooth and even coating surface is the key factor, which required the holographic coating to carry high brightness and good flowing smooth. Furthermore, other physical and chemical performance of the coating, such as folding strength, antifriction, post processing adaptability, etc. is also very important.

From the point view of optics, to record holographic image on the coating is to produce such holographic effect by means of optical diffraction effect, while the former printing image with printing ink is to present the printing effect by means of optical reflection effect. Due to the difference of utilizing light, the holographic image does not interfering the former effect printed with ink, on the contrary, the transparent holographic coating can make the two type of printing effect to present them at the same time, and form a special decoration effect.

The major technical characteristics are as follows when adopting this invention:

A. This technology can produce laser holographic image on the printed surface of basis material. The transparent holographic image can cooperate with the image printed with printing ink to achieve a special anti-counterfeiting printing effect by means of reasonable decoration design.

B. The transparent holographic image achieved by this technology will not damage the former printed effect, and it is unnecessary to metalized (or any other inorganic compound) layer, furthermore, the post printing treatment equipment can be fully utilized to combine with the current printing technique process.

C. As one process of post printing treatment, the holographic coating also has the function of protecting the printing surface, and it carries the characteristics of high brightness, waterproof, abrasion proof, etc.

D. The involved holographic coating contains no poisonous substance, and the holographic matter generated does not contain plastic film or metal media, so it is a kind of environment protection matter which can be completely recycled.

### BRIEF DESCRIPTION OF THE DRAWINGS

FIG. 1 is a flow chart for producing technology

FIG. 2 is a schematic drawing for product texture

FIG. 3 is a schematic drawing for machining method

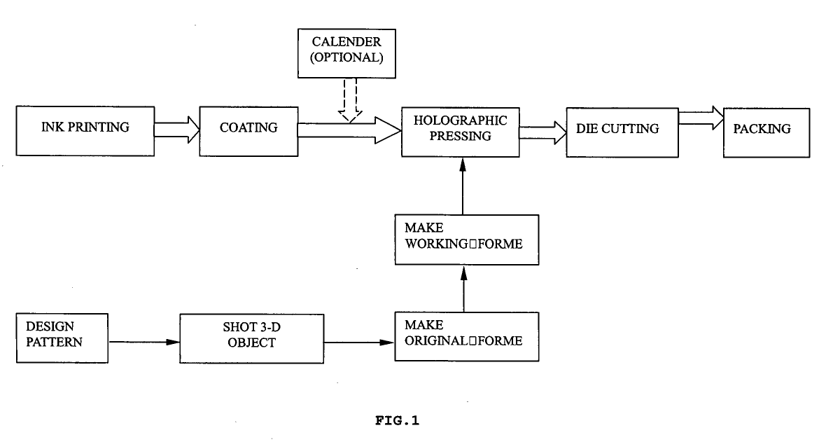

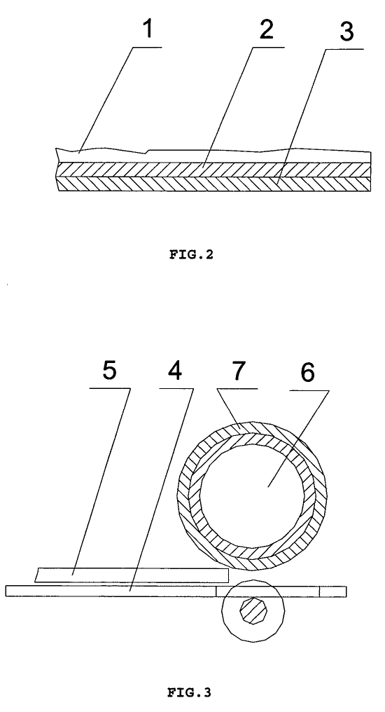

Wherein:

1. holographic coating layer 2. printing layer 3. basis material 4. embossing machine, 5. basis material with holographic coating layer 6. embossing mold 7. laser holographic form

### DETAILED DESCRIPTION OF THE EMBODIMENTS

The following is detailed description of the invention integrated with figures and examples:

It can be seen from the figures that the products of this invention are made up of holographic coating layer 1, printing layer 2 and basis material 3. Holographic image is heat-embossing produced by embossing mold 6 on the embossing machine 4 and laser holographic form 7, then forming transparent holographic image layer on the surface of printing layer, so creating product with holographic image layer.

### EXAMPLE 1

Employ white paper board as the basis material and water soluble holographic coating. The producing method is as follows:

1. The preprinting basis material is ink printed by conventional printing machine and is turned into flake-shaped paper.

2. Synthetising 200 portion of water soluble resin with 100 portions of water soluble emulsion to form a kind of copolymerised emulsion, and adding polyvinyl alcohol to form host agent, then adding 100 portions of solvent water, 100 portions of glycol ether and 100 portions of butanol to form water soluble copolymrised resin emulsion holographic coating.

3. Adopting infrared drying three-roller coating machine to coat said holographic coating on the post printing plane paper, then conveying the basis material brushed with holographic coating to the calendar to press after dried by infrared heater to increase the smoothness and brightness of holographic coating layer. The steel belt type of calender can be chosen as the suitable one.

4. Conveying the basis material sheet with holographic coating layer to the panel embosser for holographic embossing and reproducing. The panel embosser is a kind of rolling unit, the holographic roller of which is a hollow roller whose center is filled with thermal oil to heat and soften the holographic coating layer on the basis material. The sleeve of the holographic roller is holographic model. The designed process parameter is as follows: oil temperature 150° C., axle temperature 100° C., and pressure 2 Mpa, machine speed 600 rpm. Caution: The temperature of thermal press should not be too high, otherwise the adhesive phenomenon will be caused due to the greater adhesion of the coating, i.e., the paper plates get winded on the holographic pressing roller because they are not peeled off in time. Such situation should be prevented from happening in the practical production.

5. Peeling and cooling the sheet material which has been produced by holographic embossing, the printed sheet material with holographic image comes into being.

### EXAMPLE 2

Employ metal sheet as the basis material and alcohol borne holographic coating. The producing method is as follows:

1. Printing the basis material to be printed with regular oil printing machine to achieve a flat metal printing material with certain color and pattern.

2. Synthetise 200 portions of copolymerised resin and 100 portions of polyaminoester resin as host agent with 100 portions of solvent glycol ether and 100 portions of butanol to form alcohol copolymrised resin holographic coating.

3. Spray painting prescribed holographic coating on the tin plate printing, and then dry the sheet basis material with holographic coating after dried by infrared heater.

4. Embossing the sheet basis material with holographic coating layer in the panel embosser for holographic embossing and reproducing. The panel embosser is a kind of rolling unit, the holographic roller of which is a hollow roller, whose center is filled with thermal oil to heat and soften the holographic coating layer on the basis material. The sleeve of the holographic roller is holographic model. The designed process parameter is as follows: oil temperature 150° C., axle temperature 100° C., and pressure 2 Mpa, machine speed 600 rpm.

5. Peeling and cooling the sheet material which has been produced by holographic embossing, the printed sheet material with holographic image comes into being.

1. A method of creating holographic image on printed surface comprising the following steps:
A. Selecting a basis material;
B. Printing conventional printing pattern layer upon said basis material layer;
C. Coating a transparent medium of holographic coating layer used to create holographic pattern upon said surface of printed pattern layer, wherein said medium is transparent thermoplastic material containing solvent type copolymerised resin; the holographic coating layer is produced by the holographic coated medium heated and dried by the infrared;
D. Embossing said material with holographic coating layer by heating installing dolographic form on the outer surface of the form roller of the embossing machine; when said material with holographic coating layer is conveyed to the embossing machine, the holographic coating layer is embossed and the holographic image is produced under the pressure of the holographic form while the holographic coating layer is softened by heat.

2. The method of creating holographic image on printed surface of claim 1, wherein said layer is coated by means of rolling, or spraying, or brushing, or sprinkling.

3. The method of creating holographic image on printed surface of claim 1, wherein said emboss method is rolling pressed by heating, the embossing mould of the embossing machine is a hollow roller, whose hollow house is filled with heated oil for softening holographic coating layer, the holographic form for producing holographic image is installed on the outer surface of the roller.

4. The method of creating holographic image on printed surface of anyone of claims 1-3, wherein said basis material layer is paper basis material.

5. The method of creating holographic image on printed surface of anyone of claims 1-3, wherein said basis material layer is metal basis material.

6. The method of creating holographic image on printed surface of anyone of claims 1-3, wherein said basis material layer is leather basis material.

7. The method of creating holographic image on printed surface of claims 1-3, wherein said basis material layer is plastic basis material.

8. The method of creating holographic image on printed surface of claim 1, wherein said holographic coating medium is a kind of transparent thermoplastic water soluble copolymerised resin coating in which the host agent contains water soluble resin and polyvinyl alcohol, said solvent contains water, glycol ether and butanol.

9. The method of creating holographic image on printed surface of claim 1, whereinsaid holographic coating medium is a kind of transparent thermoplastic alcohol soluble copolymerised resin coating in which the host agent contains monomer copolymerised resin and polyaminoester resin, said solvent contains glycol ether and butanol.
